(19) United States
(12) Patent Application Publication
(10) Pub. No.: US 2005/0042443 A1
(43) Pub. Date: Feb. 24, 2005

(54) PVOH barrier performance on substrates

(76) Inventor: Gerald D. Miller, Humble, TX (US)

Correspondence Address: M. Susan SPIERING;c/o Celanese Ltd., IP Legal Dept., IZIP 701, HWY 77 S, BISHOP, TX, 78343, US

(21) Appl. No.: 10/859,023

(22) Filed: Jun. 2, 2004

Related U.S. Application Data
(60) Provisional application No. 60/497,291, filed on Aug. 22, 2003.

(51) Int. Cl. B32B 27/00; B32B 27/10; B05D 1/30

(52) U.S. Cl. 428/341; 428/342; 428/500; 428/511; 427/420

(57) ABSTRACT

Disclosed are coated substrates and methods for producing coated substrates. At least one surface of the substrates is coated with a polyvinyl alcohol polymer to render the substrates resistant to oil and grease. The polyvinyl alcohol polymer is coated at levels of a least 7 g/m², based upon area of the coated surface of the substrate. Alternatively, the coating concentration is at least 5 wt. % of the weight of the substrate. The coatings may be applied by curtain coating or means and comprise at least one layer of a polyvinyl alcohol solution.

### BACKGROUND OF THE INVENTION

Oil and Grease Resistance Paper (OGR Papers) falls under the umbrella category of “packaging papers.” Packaging in itself includes a wide array of substrates such as paper, paperboard, plastic, fiberglass, canvas or cloth/textile substrates, or the like. Historically, polyvinyl alcohol (PVOH) usage in OGR Papers has been minimal relative to market size, despite the fact that it is inherently hydrophilic, and therefore highly resistant to oils, greases and most organic solvents. This is because it is applied mostly by size presses that limit the amount of PVOH added to the substrate, and therefore confine PVOH to a discontinuous film. As a continuous film, PVOH, whether free or cast onto a substrate, has been demonstrated to be a barrier, in some cases a total barrier, to oils, greases and most organic solvents.

Generally, PVOH is used to improve the performance of starch for simple grease resistance requirements. However, for higher end requirements, with more aggressive target specifications fluorochemicals (FC) are commonly used. While PVOH has been used as a carrier with FC's in the past starch is much more commonly used as a carrier.

For purposes of this invention, higher end versus lower end requirements means that the requirements of the paper are greater, stricter, or higher than lower end.

OGR papers are primarily used for applications such as pet food liner bags, popcorn bag liners, microwavable food liners, liners to be used in food packaging items such as pizza boxes, popcorn boxes/bags, butter wraps, bakery items, fast food wraps (e.g., hamburgers, hot dogs, French fries containers, etc). Applications also may include fireplace starter log wraps, silicone release liners, etc.

The present invention is directed for use in all traditional applications noted above, but primarily in food applications, and may also include oil (as in motor oil) containers and cosmetic packaging. Packaging which is in need of barrier type properties; barriers which are oil and grease resistant or barriers for organic solvents such as in charcoal (with lighter fluid) packaging may also utilize the present inventive concept. Typical charcoal packaging is pre-fluidized wherein the package needs special barriers to avoid leakage of the fluid.

Other OGR barriers are polyethylene (PE) films such as are used for milk carton stock. Current problem with today's PE barriers are their inability to repulp or biodegrade. Hence PVOH films have this advantage over PE films.

Presently, because of equipment limitations, the add-on levels of PVOH onto substrates for use in the OGR market is low. Generally PVOH solutions are applied on the paper machines at the size presses. The size presses are limited by viscosity as to how much one can put on the paper. So for example, a typical add on level of PVOH to the paper would be approximately 0.3-2.0% PVOH (dry PVOH based on dry fiber) which generally translates to about 6-40 lb/ton of add-on. By the nature of the size press, solutions tend to penetrate and not stay on the surface of the paper. Because of this, PVOH applications to paper are traditionally used in discontinuous films. In other words, the PVOH is applied as discontinuous regions, or patches, on the surface of the substrate. The capability for multiple applications on today's paper machines is rare and costly. This results in substrates having incomplete barrier properties. This is a problem in the art the invention will address. The PVOH does not participate to a large extent on these OGR grades of paper. Those of skill in the art will recognize that these types of OGR base papers are processed differently than many other types of papers.

The market is currently satisfied with the performance of FC's relative to their use in OGR applications. FC's excel on flat, crease, and edge tests since they tend to reduce the surface energy of exposed fibers. However, FC's are very expensive materials for use in coating substrates.

There is a perception among some in the papermaking industry that all FC's will ultimately exit the marketplace due to some negative results from environmental and human studies with the material. Thus there is a need for an alternate to FC's for use in the paper or textile industry that have similar or superior properties relative to oil and grease resistance or barrier.

U.S. patent application Ser. No. 2003/0194501 discloses processes for coating substrates in which coating compositions incorporating polyvinyl alcohol are applied with a curtain coater. The application discloses that the polyvinyl alcohol is included as a compound capable of reacting with another compound in the coating to facilitate coating gel formation. See also, U.S. patent application Ser. Nos. 2003/0188839 and 2003/0194501 for disclosures of curtain coating substrates with coatings incorporating polyvinyl alcohol.

### SUMMARY OF THE INVENTION

Disclosed herein are coated substrates and methods of producing the coated substrates. At least one surface of the substrates is coated with at least one layer of a polyvinyl alcohol polymer coating. The substrates have oil and grease resistant, or oil and grease barrier properties. The polyvinyl alcohol coatings may be applied to the surface of the substrates a curtain coater or other means. The coatings comprise at least one layer, formed by coating in single, simultaneous, or multiple passes, with a solution of PVOH (any grade of PVOH is acceptable) onto a substrate (paper, paperboard, plastic, fiberglass, canvas or cloth/textile substrates, or the like). The coating is then dried.

As used herein, “near continuous” means close to continuous but not an actual continuous film, i.e., a film having some pin holes, whereas “continuous” is considered essentially pin-hole free. A discontinous or noncontinuous film is intended to mean a film containing pinholes. The coated substrate-will possess oil and grease resistant properties greater than conventionally (single pass) formed PVOH based OGR coatings. Optionally, the PVOH solution employed herein may contain other components such as other polymers, thus utilizing copolymers of PVOH as the solution to coat onto a substrate. The PVOH may contain additives such as plasticizers, starch, lattices, fillers, and the like.

The coating may comprise multiple layers of 2 or greater number. The number of possible layers is only limited by the die or equipment utilized with the said curtain coater. It is envisioned that anywhere from about 7 to about 20 layers is possible in a single pass with the curtain coater, wherein at least one of the layers is a PVOH solution or copolymer of PVOH solution. The PVOH solution contains at least about 1% PVOH solids, although higher levels may be employed.

### DETAILS OF THE INVENTION

Curtain coaters are capable of applying multiple layers of PVOH solution to possibly achieve a continuous dried film of PVOH onto a substrate, in particular those of paper or paperboard on a single pass, without the need to transfer and to glue to the paper. This differs from conventional papermaking that utilizes size presses, calendar stack boxes and coaters (blade, air-knife, roll, rod, etc). While curtain coaters have existed for at least 30 years, in terms of paper use they have historically been used only for the photographic film industry or other highly specialized applications. Curtain coaters are not known by the industry community to be generally useful in making OGR barrier paper products which contain PVOH. Curtain coaters may be used to coat PVOH solutions in single, simultaneous, or multiple passes, to apply one or more PVOH coating layers on at least one surface of a substrate in accordance with this disclosure. The coating processes described herein may be used to produce coatings that are continuous or near-continuous. The phrases “continuous” and “near-continuous” are used to describe the physical coverage of the coating on the substrate. Of course, the barrier effectiveness of the coating on the substrate is more accurately determined by the barrier test methods described hereinafter.

It appears the market has not considered using curtain coaters for the purpose of producing PVOH-OGR barrier films. It is possible that this is so, because curtain coaters have historically been isolated for use in the photographic industry or to coat thermal paper.

It is also believed that curtain coaters were not used to coat PVOH layers on substrates previously because it was thought, by those in the industry, that PVOH solutions would not form a “curtain” for application with a curtain coater. As described herein, it has been surprisingly determined that PVOH solutions may be applied in a “curtain” to coat substrates.

A curtain coater is a specialized machine used to apply single or multiple liquid layers in a single pass; multiple layers, such as in the range of about 7-20 layers or more are possible. The number of layers is generally limited by the equipment employed. Fluids pass through a layer slide die, detach from the die lip forming an unsupported liquid sheet that falls by gravity onto a moving web. The number of layers can be expanded at will. In the present application, the number of layers can be defined by the number necessary to form a continuous or near continuous PVOH dried film.

Additional layers (other than the initial PVOH solution layer) to be placed in a single pass include for example, plasticizer, PVDC for moisture vapor transmission improvement, pigments, starch, lattices, and the like. The single, simultaneous, or one pass is important because paper makers are hesitant to place paper through a machine twice. The PVOH is important since it will provide the OGR barrier. Continuous is important since oil and grease can be blocked. With a non-continuous PVOH film, oil and grease can leak through pin holes in the film.

By using a curtain coater, it is possible to apply more PVOH in a single pass to achieve the same desired end result compared with other application technologies. The curtain coater will tend to coat the surface since there is no pressure at point of contact with the paper.

It has been discovered that curtain coaters are effective to apply PVOH solution coatings onto substrates at PVOH concentrations and add-on levels sufficient to achieve effective oil and grease barrier properties, particularly in commercial operations. However, it is significant to note that the satisfactory oil and grease barrier properties may be attained by coating PVOH solutions onto substrates by techniques other than curtain coating as long as the concentration and add-on of the PVOH are at the levels described herein. It is believed that these PVOH coating levels were not previously practiced on substrates because it was thought that these high PVOH concentrations or add-ons would not dry in a manner allowing effective use of the coatings. An aspect of the coated substrates and processes described herein is that is has been surprisingly determined that such high PVOH concentrations and add-ons may be dried in commercial operations to form effective oil and grease barrier coatings.

Laboratory work has shown that PVOH films on paper are total barriers to oil greases and organic solvents. With plasticizers, they can allow for heat sealing and for passing the difficult crease test.

The coated substrates described herein pass many of the industry standard tests for OGR films. For example, with the 3M Kit test, a 12 rating is considered the maximum rating achievable. A coating of PVOH laminated to a paper substrate has been found to obtain a 12 without any problems associated with the film.

In one embodiment, the coated substrates described herein exhibit 3M kit test values of at least 4. In a second embodiment, the coated substrates described herein have 3M kit test values of at least 8. In still another embodiment, the coated substrates exhibit 3M kit values of at least 10.

This test is simple and designed to be fast. A drop of solvent, e.g., a heptane-toluene blend, is placed on the surface of a board and wiped off in about 15 seconds. If the solvent does not penetrate the board within this time frame, the film passes the test. Laboratory studies employing a drop of heptane-toluene blend solvent and a PVOH film made by conventional casting methods resulted in a pass of the Oil Holdout Test. The drop will not penetrate the film for the lifetime of the film.

Another important industry test is the crease test. The crease test involves a barrier paper which is folded on itself and pressed with a weighted roller to expose fibers along the crease. FC's typically pass or excel the crease test. However, conventionally formed films wherein the barrier material is applied off of the size press, such as PVOH, starch, etc, generally have not passed the crease test. Under laboratory conditions using a typical OGR base paper, it has been demonstrated that if the PVOH add-on level is approximately 5% dry on dry fiber, the PVOH treatment passes the crease test, as tested under TAPPI conditions of 50% relative humidity. It has been found that generally a plasticizer is needed with PVOH (to provide for flex properties) in low relative humidity conditions.

However, it is understood that the requisite add-on level is dependent on the nature of the substrate selected for coating. For example, the necessary add-on level of a relatively thick substrate may be considerably less that the necessary add-on level for a thinner, or less dense, substrate. However, in accordance with this disclosure, it is generally found that a PVOH add-on level of at least 5% will provide all types of substrates will high levels of oil and grease resistance as demonstrated by the experimental evaluation results presented hereinafter. In another embodiment, the add-on level of the PVOH is from about 7% to about 10%. In still another embodiment, the PVOH add-on level is from about 10% to about 15%.

Alternatively, in one embodiment, it has been determined that satisfactory oil and grease resistance may be obtained with substrate surface coatings including at least 7 g/m² of PVOH. In a second embodiment, the substrate surface coating has from about 10 g/m² to about 20 g/m² of PVOH. In still another embodiment, the substrate is coated on at least one surface of about 10 g/m² to about 15 g/m².

PVOH of various grades may be used as a solution with the present inventive process. It has been determined that generally it is desirable to include a plasticizer in the PVOH solutions described herein, particularly in low relative humidity conditions. However, it is understood that coatings prepared using PVOH solutions not incorporating a plasticizer are within the contemplation of this disclosure. In one embodiment, the PVOH's used in the products and processes described herein have a weight average molecular weight (M_{w}) ranging from about 10,000 to about 200,000. In another embodiment, the PVOH's have a weight average molecular weight (M_{w}) of 20,000 to 130,000. In one embodiment, the PVOH's have a degree of polymerization (Dp) of from about 100 to about 3,000. In another embodiment, the degree of polymerization of about 200 to about 1,600.

Polyvinyl alcohol is made commercially by the hydrolysis of poly(vinyl acetate) and typically has a hydrolysis level ranging from about 85% to greater than 99%. In the one embodiment of the products and processes described herein, the level of hydrolysis ranges from 50% to 100%. In another embodiment, the degree of hydrolysis is from 75% to 98%. Mixed polyvinyl alcohol grades, using combinations of polyvinyl alcohol polymers varying in molecular weight and polymer hydrolysis level, can also be employed in various embodiments of the processes and products described herein.

Those of skill in the art will recognize that typically the PVOH solution goes through a cooked cycle. Also useful as a solution for curtain coating technology are copolymers of PVOH. These would include reaction products of (meth)acrylate, vinyl acetate and co-monomers that would allow post saponification. As used herein, the terms “PVOH” “polyvinyl alcohol polymer” and “PVOH polymer” include polyvinyl alcohol homopolymers, copolymers incorporating at least one co-monomer, and blends thereof unless otherwise noted.

One such useful copolymer includes a copolymer of vinyl alcohol and 2-acrylamido-2-methyl propane sulfonic acid or a salt of such acid. A copolymer of vinyl alcohol (VOH) and 2-acrylamido-2-methyl propane sulfonic acid or a salt of such acid (AMPS) by steps including continuously feeding with agitation, vinyl acetate (VAM) and AMPS as co-monomers, a free radical yielding polymerization initiator, and a solvent for said co-monomers, initiator, and copolymer resulting from the copolymerization of said co-monomers, maintaining the resulting reaction mass in said first reaction zone under polymerization conditions for a residence time sufficient for a major proportion of AMPS fed to said first reaction zone to polymerize, continuously feeding reaction mass from said first reaction zone with an additional supply of AMPS to a second reaction zone, maintaining the reaction mass in the second reaction zone for a residence time sufficient to polymerize a major proportion of the AMPS added to the second reaction zone, continuously withdrawing reaction mass from the second reaction zone, separating copolymer of VAM and AMPS from the latter reaction mass, and saponifying by hydrolysis and/or alcoholysis a major proportion of the acetate groups in said copolymer to form a copolymer of VOH and AMPS.

Other useful polyvinyl alcohol polymers include copolymers incorporating at least one co-monomer such as ethylene, a carboxylic acid, a branched alkyl acid vinyl ester such as vinyl esters of alpha-branched carboxylic acids having 5 and 9 to 11 carbon atoms available from Resolution Performance Products under the designations VeoVa®, acryl amides, and other commoners. It is understood that the term “copolymer” as used herein is a polymer incorporating at least two monomer units and therefore includes terpolymers and the like.

In one embodiment, the PVOH solutions may be prepared with a PVOH solids content from about 1% to about 30%. In a second embodiment, the solutions have a PVOH solids content of about 5% to about 25%. In still another embodiment, the solutions may have a PVOH solids content from about 7% to 15%.

In addition to the PVOH's, the solutions may have solids content derived from additives in the solutions. For example, the solutions may contain additives such as surfactants, plasticizers, and pigments. In one embodiment, these additives may contribute up to 30% solids in the solutions in addition to solids contents provided by the PVOH's.

Laboratory studies with the AMPS modified copolymer indicate that indeed dried film is quite noticeably softer and more flexible than standard grade PVOH's. Samples of this film were adhered to the surface of paper and tested for the standard crease test as tested at 50% relative humidity as per TAPPI conditions. By the TAPPI turpentine crease test calling for 30 minutes resistance to turpentine, the PVOH AMPS film on paper passed. It also passed the 3M Kit Flat Test.

Also conducted were Kit and Crease tests with standard grades of PVOH. PVOH solution of grade Celvol® 325 was used to produce a film, by casting onto a glass plate, the film approximately 1 mil thick, and dried at ambient temperature for about 24 hours. It was observed that the film passed both the flat and the crease test. Observations indicated standard grades of PVOH are not as flexible as copolymer/coamps PVOH. However, there is still some flex to the film observed at 50% relative humidity.

The following testing methods that are frequently used to determine the oil and grease resistant properties of substrate coatings are useful to evaluate the products and processes described herein:

TAPPI T-508 cm-99 Grease Resistance Of Flexible Packaging Materials

TAPPI T-559 pm-96 Grease Resistance Test For Paper and Paperboard

Oil Penetration Time

3M Kit Flat Test

TAPPI method T-454 Flat Test (based on turpentine 1800 second holdout)

Turpentine Crease Test (based on 1800 second)

TAPPI T-462 om-93 Castor Oil Penetration Test For Paper

Vegetable Oil T-507 Test @ 60° C.

Experimental Evaluations

Table I details the composition and performance characteristics of thirty-seven (37) polyvinyl alcohol coated substrate structures prepared in curtain coater processes. In each of the coated substrate structures prepared, the substrate was a densified paper substrate having a weight of 55 grams per square meter with a 3M Kit Test value or 3. The coatings were applied in with the curtain coater as a water-based solution having a solids contents ranging from 7.4% to 15.1% as noted hereinafter. The polyvinyl alcohol polymers were the only dissolved solids with the exception of a surfactant, included to assist in maintaining a stable curtain, and a plasticizer in some of the Celvol® 107 formulations for improved flexibility of the PVOH film. The surfactant used was a liquid commercially available from Air Products & Chemicals under the designation Surfynol SE-F. The surfactant was incorporated at a concentration of 0.075% -0.15% wet/wet basis. The plasticizer was Glycerine, commercially available from All Chem Industries, added to the PVOH solution at 10% wet parts based on dry parts Celvol® 107.

Each solution was prepared using one or more of polyvinyl alcohol polymer products available from Celanese Chemicals under the designations Celvol® 107, Celvol® 125, and Celvol® 205. These polyvinyl alcohol polymers are hompolymer grades. Celvol® 107 has a degree of hydrolysis % of 98.0 to 98.8, a viscosity at 4.0% solids and 20° C. of 5.5 to 6.6 cps, and a pH of 5.0 to 7.0; Celvol® 125 has a degree of hydrolysis % of 99.3, a viscosity at 4.0% solids and 20° C. of 28.0 to 32.0 cps, and a pH of 5.5 to 7.5; and Celvol® 205 has a degree of hydrolysis % of 87.0 to 89.0, a viscosity at 4.0% solids and 20° C. of 5.2 to 6.2 cps, and a pH of 4.5 to 6.5.

The solutions prepared incorporating Celvol® 125 had a PVOH solids content of 7%, solutions prepared with Celvol® 107 had a solids content of 15%, and solutions incorporating Celvol® 205 had a solids content of 13%.

As noted in Table I, some of the coated substrates were prepared by curtain coating the identified PVOH solutions in a single layer on the first surface of the substrates. Alternatively, as noted in Table 1, some of the substrate structures were prepared by curtain coating multiple layers on the first surface of the substrates. The curtain coater was adjusted to deliver the necessary amounts of the PVOH solutions to achieve the coating concentrations or levels of add-on of PVOH on the surfaces of the substrates as indicated in Table I. Following application of the PVOH solutions, the substrates were dried at multiple stations and at the temperatures indicated in Table 1.

As indicated in Table I, Vegetable Oil Test results TAPPI were collected for certain exemplary coated substrates.

TABLE 1

| | | | | | Line | | | | | | | | | |
|---|---|---|---|---|---|---|---|---|---|---|---|---|---|---|
| | Layer 1 | Layer 2 | PVOH | PVOH | Speed | [symbol] Drier Section ° C. [symbol] | | | | | | | | |
| Example | Celvol ® | Celvol ® | (g/m²) | (% Add-on) | m/min | 1 Top | 1 Bot | 2 Top | 2 Bot | 3 Top | 3 Bot | 4 Top | 4 Bot | ° C.¹ |
| 1 | 107 | N/A | 7.0 | 11.3 | 150 | 170 | 170 | 190 | 190 | 220 | 220 | 220 | 220 | 96 |
| 2 | 107 | N/A | 5.0 | 8.3 | 200 | 170 | 170 | 190 | 190 | 220 | 220 | 220 | 220 | 100 |
| 3 | 107 | N/A | 3.0 | 5.1 | 300 | 170 | 170 | 190 | 190 | 220 | 220 | 220 | 220 | 113 |
| 4 | 107 | N/A | 7.0 | 11.3 | 150 | 170 | 170 | 200 | 200 | 230 | 230 | 230 | 230 | 153 |
| 5 | 107 | N/A | 10.0 | 15.4 | 120 | 170 | 170 | 200 | 200 | 230 | 230 | 230 | 230 | 112 |
| 6 | 107/Plas | 107 | 1.75/5.25 | 11.3 | 150 | 170 | 170 | 200 | 200 | 230 | 230 | 230 | 230 | 113 |
| 7 | 107/Plas | 107 | 3.5/3.5 | 11.3 | 150 | 170 | 170 | 200 | 200 | 230 | 230 | 230 | 230 | 116 |
| 8 | 107/Plas | 107 | 5.25/1.75 | 11.3 | 150 | 170 | 170 | 200 | 200 | 230 | 230 | 230 | 230 | 126 |
| 9 | 107/Plas | 107 | 2.5/7.5 | 15.4 | 120 | 170 | 170 | 200 | 200 | 230 | 230 | 230 | 230 | 82 |
| 10 | 107/Plas | 107 | 5.0/5.0 | 15.4 | 120 | 170 | 170 | 200 | 200 | 230 | 230 | 230 | 230 | 87 |
| 11 | 107/Plas | 107 | 7.5/2.5 | 15.4 | 120 | 170 | 170 | 200 | 200 | 230 | 230 | 230 | 230 | 95 |
| 12 | 107/Plas | 107 | 3.75/11.25 | 21.4 | 80 | 170 | 170 | 200 | 200 | 230 | 230 | 230 | 230 | 85 |
| 13 | 107/Plas | 107 | 12.0/0 | 17.9 | 100 | 170 | 170 | 210 | 210 | 240 | 240 | 240 | 240 | 131 |
| 14 | 107/Plas | 107 | 6.0/6.0 | 17.9 | 90 | 170 | 170 | 210 | 210 | 240 | 240 | 240 | 240 | 129 |
| 15 | 107/Plas | 107 | 0/12.0 | 17.9 | 85 | 170 | 170 | 210 | 210 | 240 | 240 | 240 | 240 | 134 |
| 16 | 107/Plas | 107 | 0/11.9 | 17.8 | 93 | 170 | 170 | 200 | 200 | 230 | 230 | 230 | 230 | 90 |
| 17 | 107/Plas | 107 | 12.0/0 | 17.9 | 100 | 170 | 170 | 200 | 200 | 230 | 230 | 230 | 230 | 114 |
| 18 | 107/Plas | 107 | 6.0/6.0 | 17.9 | 90 | 170 | 170 | 200 | 200 | 230 | 230 | 230 | 230 | |
| 19 | 107/Plas | 107 | 6.0/6.0 | 17.9 | 95 | 170 | 170 | 200 | 200 | 230 | 230 | 230 | 230 | 97 |
| 20 | 205 | N/A | 7.0 | 11.3 | 160 | 170 | 170 | 200 | 200 | 230 | 230 | 230 | 230 | 133 |
| 21 | 205 | N/A | 7.0 | 11.3 | 170 | 170 | 170 | 200 | 200 | 230 | 230 | 230 | 230 | 115 |
| 22 | 205 | N/A | 10.0 | 15.4 | 170 | 170 | 170 | 200 | 200 | 230 | 230 | 230 | 230 | 114 |
| 23 | 205 | N/A | 12.0 | 17.9 | 100 | 170 | 170 | 200 | 200 | 230 | 230 | 230 | 230 | 112 |
| 24 | 205 | N/A | 14.0 | 20.3 | 85 | 170 | 170 | 200 | 200 | 230 | 230 | 230 | 230 | 116 |
| 25 | 205 | N/A | 14.0 | 20.3 | 90 | 170 | 170 | 200 | 200 | 230 | 230 | 230 | 230 | 99 |
| 26 | 125 | N/A | 6.0 | 9.8 | 95 | 170 | 170 | 200 | 200 | 230 | 230 | 230 | 230 | 89 |
| 27 | 125 | N/A | 6.0 | 9.8 | 100 | 170 | 170 | 200 | 200 | 230 | 230 | 230 | 230 | 110 |
| 28 | 125 | N/A | 9.0 | 14.1 | 70 | 170 | 170 | 200 | 200 | 230 | 230 | 230 | 230 | 107 |
| 29 | 125 | N/A | 9.0 | 14.1 | | 170 | 170 | 200 | 200 | 230 | 230 | 230 | 230 | 83 |
| 30 | 125 | N/A | 10.0 | 15.4 | 60 | 170 | 170 | 200 | 200 | 230 | 230 | 230 | 230 | 81 |
| 31 | 125 | N/A | 10.0 | 15.4 | 55 | 170 | 170 | 200 | 200 | 230 | 230 | 230 | 230 | 118 |
| 32 | 125 | N/A | 12.0 | 17.9 | 50 | 170 | 170 | 200 | 200 | 230 | 230 | 230 | 230 | 83 |
| 33 | 205 | 125 | 5.25/1.75 | 11.3 | 130 | 170 | 170 | 200 | 200 | 230 | 230 | 230 | 230 | 129 |
| 34 | 205 | 125 | 5.25/1.75 | 11.3 | 140 | 170 | 170 | 200 | 200 | 230 | 230 | 230 | 230 | 100 |
| 35 | 205 | 125 | 7.5/2.5 | 15.4 | 90 | 170 | 170 | 200 | 200 | 230 | 230 | 230 | 230 | 130 |
| 36 | 205 | 125 | 7.5/2.5 | 15.4 | 100 | 170 | 170 | 200 | 200 | 230 | 230 | 230 | 230 | 94 |
| 37 | 205 | 125 | 9.0/3.0 | 17.9 | 80 | 170 | 170 | 200 | 200 | 230 | 230 | 230 | 230 | 101 |

| | | TAPPI | | | Vegetable Oil @ 60° C. | |
|---|---|---|---|---|---|---|
| | | Turpentine | | 3M Kit | w/press. (T507) | |
| Example | Surfynol % | Flat | Crease | Flat | Flat (min) | Crease (min) |
| 1 | 0.15 | 1800+ | 100 | 11 | | |
| 2 | 0.15 | | | 2 | | |
| 3 | 0.15 | | | 1 | | |
| 4 | 0.15 | | | 7 | | |
| 5 | 0.15 | 1800+ | 300 | 12 | | |
| 6 | 0.15 | | | 7 | | |
| 7 | 0.15 | | | 7 | | |
| 8 | 0.15 | | | 8 | | |
| 9 | 0.15 | 1800+ | 40 | 12 | | |
| 10 | 0.15 | 1800+ | 1800+ | 12 | 60 | Not tested |
| 11 | 0.15 | 1800+ | 630 | 12 | | |
| 12 | 0.15 | No Sample (poor drying) | | | | |
| 13 | 0.15 | 1800+ | 300 | 12 | | |
| 14 | 0.15 | | | 12 | | |
| 15 | 0.15 | 1800+ | 90 | 11 | | |
| 16 | 0.15 | 1800+ | 195 | 10 | | |
| 17 | 0.15 | 1800+ | 1035 | 12 | | |
| 18 | 0.15 | 1800+ | 95 | 10 | | |
| 19 | 0.15 | 1800+ | 765 | 12 | | |
| 20 | 0.075 | 1800+ | 870 | 12 | | |
| 21 | 0.075 | 1800+ | 545 | 12 | | |
| 22 | 0.075 | 1800+ | 1095 | 12 | | |
| 23 | 0.075 | 1800+ | 1800+ | 12 | 180 | Not tested |
| 24 | 0.075 | 1800+ | 1800+ | 12 | 180 | Not tested |
| 25 | 0.075 | 1800+ | 1800+ | 12 | 240+ | 120 |
| | | | no test | | | |
| 26 | 0.15 | 1800+ | (pin holes) | 8 | | |
| | | | no test | | | |
| 27 | 0.15 | 1800+ | (pin holes) | 6 | | |
| 28 | 0.15 | 1800+ | 1050 | 11 | | |
| 29 | 0.15 | 1800+ | 1260 | 12 | | |
| 30 | 0.15 | 1800+ | 1800+ | 12 | 240+ | 240+ |
| 31 | 0.15 | 1800+ | 1800+ | 12 | 60 | Not tested |
| | | | no test | | | |
| | | | (surface | | | |
| 32 | 0.15 | 1800+ | craters) | 9 | | |
| 33 | 0.075-0.15 | 1800+ | 1800+ | 12 | 240+ | 240+ |
| 34 | 0.075-0.15 | 1800+ | 1800+ | 12 | 240+ | 120 |
| 35 | 0.075-0.15 | 1800+ | 1020 | 12 | | |
| 36 | 0.075-0.15 | 1800+ | 1800+ | 12 | 240+ | 240+ |
| 37 | 0.075-0.15 | 1800+ | 1800+ | 12 | 240+ | 60 |

¹Substrate temperature at conclusion of drying process.

By reviewing the data reported in Table 1, it is seen that coatings containing high levels of polyvinyl alcohol polymers are necessary to achieve satisfactory oil and grease resistance performance. For example, it is seen that PVOH add-on percentage levels ranging of at least about 7% were necessary to achieve satisfactory oil and grease resistance as indicated by the 3M Kit Test data. While this add-on percentage is higher than the experimental results referred to above that identified at least 5% add-on as minimum for satisfactory barrier, the differences in barrier performance are thought to arise from differences in the substrates coated and the manner in which multiple PVOH layers were coated. In the experimental data referred to previously, the substrate was paper have a weight of 55 g/m². With respect to the coating method, the experimental work referred to previously, each multiple wet layer of PVOH solution applied was oven dried before the succeeding layer was applied. Whereas, in the curtain coater processes used to produce the coated substrates reported in Table I, if applicable, multiple wet layers were applied in a single pass, with no drying in between layers. This is thought to be the most likely reason for the data in Table I.

Alternatively, reviewing the concentrations of the polyvinyl alcohol polymer coatings as a function of the surface area of the coated substrate surface reveals that at concentrations of at least about 7 g/m² polyvinyl alcohol polymers are necessary to achieve superior oil and grease resistance performance. Additionally, the data of Table I confirms that superior barrier performance is also obtained with PVOH coatings of about 10 g/m² to about 20 g/m².

A determining factor in the oil and grease resistance is the total concentration of the polyvinyl alcohol polymer on the surface of the substrate. In other words, no enhanced oil and grease resistance properties are observed providing multiple layers of the polyvinyl alcohol polymer onto the surface of the substrate. For example, a single coatings of a polyvinyl alcohol polymer at a concentration of 10 g/m² on the surface of a substrate provides the same oil and grease resistance as two coatings of the polyvinyl alcohol polymer at concentrations of 5 g/m² each. However, it is within the contemplation of this disclosure that the polyvinyl alcohol coating may be applied in multiple layers to one or both surfaces of the coated substrate.

The data of Table I also reveals that more consistent barrier performance was achieved with coatings based upon polyvinyl alcohol polymers having the characteristics of the Celvol® 205 PVOH as compared to the polyvinyl alcohol polymers have the characteristics of the Celvol® 107 PVOH. For example, 9 of the 10 best performing coatings were derived from Celvol® 205.

It is also observed that when two layers of different PVOH solutions were applied to a substrate surface and one of the layers was based upon Celvol® 205, better performance was achieved when Celvol® 205 was used as the lower layer. This is thought to result from Celvol® 205 forming a relatively flexible coating and because Celvol® 205 coatings are somewhat water sensitive. Therefore, in order to take advantage of the relative flexibility of the Celvol® 205 coating while minimizing the affects of water sensitivity, better performance was attained by placing the Celvol® 205 coating beneath a protective coating of another PVOH coating. However, of course, it is within the contemplation of this disclosure that a Celvol® 205 based coating may be a surface coating or may be applied in multiple coatings on a single substrate.

All patents and publications referred to herein are hereby incorporated by reference in their entireties.

Although the present invention and its advantages have been described in detail, it should be understood that various changes, substitutions, and alterations could be made without departing from the spirit and scope of the invention as defined by the following claims.

1. A coated substrate comprising:
(i) a substrate having a first and second surface;
(ii) a coating on the first surface of the substrate comprising at least about 7 g/m² of a polyvinyl alcohol polymer, based upon the surface area of the first surface of the substrate.

2. The coated substrate of claim 1 wherein the coating is a curtain coated coating.

3. The coated substrate of claim 2 wherein the substrate is comprised of at least one layer a material selected from the group consisting of paper, paperboard, plastic, fiberglass, canvas, and textile materials.

4. The coated substrate of claim 3 wherein the first surface of the substrate exhibits a resistance to vegetable oil of at least 240 minutes.

5. The coated substrate of claim 3 wherein the coating on the first surface of the substrate comprises about 10 g/m² to about 15 g/m2 of a polyvinyl alcohol polymer, based upon the surface area of the first surface of the substrate.

6. The coated substrate of claim 5 wherein the substrate is comprised of a material selected from paper and paperboard.

7. The coated substrate of claim 6 wherein the first surface of the substrate exhibits a kit test value of at least 4.

8. The coated substrate of claim 7 wherein the substrate is paper.

9. The coated substrate of claim 8 wherein the polyvinyl alcohol polymer selected from the group consisting of a homopolymer, a copolymer incorporating at least one co-monomer selected from ethylene, methyl acrylate, a carboxylic acid, an alkyl acid vinyl ester, an acryl amide, and blends thereof.

10. The coated substrate of claim 9 wherein the first surface of the substrate exhibits a turpentine crease test value of at least 1800.

11. The coated substrate of claim 10 wherein the coating is comprised of a polyvinyl alcohol polymer having a degree of hydrolysis % of 87.0 to 89.0 and a viscosity at 4.0% solids and 20° C. of 5.2 to 6.2.

12. The coated substrate of claim 11 wherein the first and second surface of the substrate comprising a coating comprising from about 10 g/m² to about 15 g/m2 of a polyvinyl alcohol polymer, based upon the surface area of the first surface and the second surface of the substrate.

13. A coated substrate comprising:
(iii) a substrate having a first and second surface;
(iv) a curtain coated coating on the first surface of the substrate comprising at least 5 wt. %, of the weight of the substrate, of a polyvinyl alcohol polymer.

14. A method of producing a coated substrate comprising coating a substrate having a first and second surface with a polyvinyl alcohol polymer at a concentration of at least about 7 g/m² on the first surface of the substrate, based upon the surface area of the first surface of the substrate.

15. The method of claim 14 wherein the step of coating the first surface of the substrate with a polyvinyl alcohol polymer is carried out by the application of an aqueous solution comprising a polyvinyl alcohol polymer to the first surface of the substrate with a curtain coater.

16. The method of claim 15 wherein the substrate is comprised of at least one layer a material selected from the group consisting of paper, paperboard, plastic, fiberglass, canvas, and textile materials.

17. The method of claim 16 wherein the aqueous polyvinyl alcohol solution has a solids content of about 7.0 wt. % to about 15.0 wt. % solids, based upon the total weight of the aqueous polyvinyl alcohol solution and the polyvinyl alcohol polymer has a degree of hydrolysis % of 87.0 to 89.0 and a viscosity at 4.0% solids and 20° C. of 5.2 to 6.2

18. The method of claim 17 wherein the aqueous polyvinyl alcohol polymer solution is applied to the first surface of the substrate at a concentration of about 10.0 g/m² to about 15.0 g/m² of the first surface of the substrate.

19. The method of claim 18 wherein a coating of a polyvinyl alcohol polymer is applied to the first and second surfaces of the substrate.

20. A method of producing a coated substrate comprising curtain coating a substrate having a first and second surface with a polyvinyl alcohol polymer at a concentration of at least 5 wt. % of the weight of the substrate.
